(19) United States
(12) Patent Application Publication
(10) Pub. No.: US 2006/0180139 A1
(43) Pub. Date: Aug. 17, 2006

(54) Portable grill

(76) Inventors: Mark T. Proffitt, Greeneville, TN (US); Stephen J. Zwonitzer, Atlanta, GA (US); Robert B. Holben, Roswell, GA (US); G. L. Huff, Afton, TN (US)

Correspondence Address: MCGUIREWOODS, LLP, 1750 TYSONS BLVD, SUITE 1800, MCLEAN, VA, 22102, US

(21) Appl. No.: 11/260,692

(22) Filed: Oct. 28, 2005

Related U.S. Application Data
(60) Provisional application No. 60/623,742, filed on Oct. 29, 2004.
(60) Provisional application No. 60/643,675, filed on Jan. 14, 2005.
(60) Provisional application No. 60/652,896, filed on Feb. 15, 2005.

(51) Int. Cl. F24B 3/00; A47J 37/00

(52) U.S. Cl. 126/25 R; 126/9 R

(57) ABSTRACT

A portable grill includes a grill housing that holds a grill structure, at least one pivot connection, a plurality of upper leg portions that are pivotally connected to the grill housing by the at least one pivot connection, and a plurality of lower leg portions attached to the upper leg portions. Additionally the plurality of lower leg portions are configured to move with respect to the plurality of upper leg portions to form a compact position of the grill.

### CROSS-REFERENCE TO RELATED APPLICATIONS

This application claims priority under 35 U.S.C. §119(e) to provisional U.S. Patent Application No. 60/623,742, filed on Oct. 29, 2004; U.S. Patent Application No. 60/643,675, filed on Jan. 14, 2005; and U.S. Patent Application No. 60/652,896, filed Feb. 15, 2005 the disclosures of which are expressly incorporated by reference herein in their entirety.

### BACKGROUND OF THE INVENTION

1. Field of the Invention

The invention is directed generally to a portable grill and, more particularly, a portable grill that may be rearranged to have a compact size so that the grill may be transported easily and safely for backyard grilling, camping, hiking, tailgating, or the like. Moreover, the invention relates to a portable gas grill having adjustable legs that allow for the positioning of the grill on an uneven surface. Additionally, the invention relates to a grill with safety features that allow for a safer cooking and/or transporting of the grill.

2. Related Art

Current gas grills typically have large bulky structures that are not meant to be positioned on uneven ground surfaces, nor easily transported. More specifically, they commonly have legs that do not have the ability to be positioned on an uneven or non-flat ground surface. In particular, the common backyard grill is a large structure that is meant to remain positioned on a flat surface such as on a patio, porch, deck or the like. Such a grill is not meant to be easily transported and accordingly does not have many safety features that may be useful for that purpose. Other types of portable grills are typically short and, as such, are not convenient to cook on because they typically may be only positioned about a foot or so off the ground and additionally have limited safety features.

Accordingly, there is a need for a grill that may adjust to non-level surfaces and may be easily and safely transported. In this regard, there is a need for a grill that may be easily rearranged into a compact size, provides for a convenient grilling height, includes safety features for transporting, and also has legs that may be adjusted independently so that the grill may be used on an uneven ground surface.

### SUMMARY OF THE INVENTION

The invention meets the foregoing need and provides a portable grill that furthermore includes other advantages apparent from the discussion herein.

The invention may be implemented in a number of ways. According to one aspect of the invention a portable grill includes a grill housing that holds a grill structure, at least one pivot connection, a plurality of upper leg portions that are pivotally connected to the grill housing by the at least one pivot connection, and a plurality of lower leg portions attached to the upper leg portions, where the plurality of lower leg portions are configured to move with respect to the plurality of upper leg portions to form a compact position of the grill.

According to another aspect of the invention a portable grill includes a grill housing that holds a grill structure, at least one pivot connection, a plurality of upper leg portions that are pivotally connected to the grill housing by the at least one pivot connection, and a plurality of lower leg portions attached to the upper leg portions, where the plurality of lower leg portions are configured to retract into the plurality of upper leg portions to form a compact position of the grill.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows a grill constructed according to the principals of the invention;

FIG. 2 shows a partial view of the grill of FIG. 1;

FIG. 3 shows a side view of a leg of the grill of FIG. 1;

FIG. 4 shows a perspective view of the FIG. 3 leg;

FIG. 5 shows a partial view of the leg of FIG. 4;

FIG. 6 shows the grill of FIG. 1 with the legs retracted and partially folded;

FIG. 7 shows a side view of the grill of FIG. 1 with legs retracted and fully folded;

FIG. 8 shows a bottom view of the grill of FIG. 7;

FIGS. 9 and 10 show exploded views of internal components of the grill of FIG. 1;

FIG. 11 shows a perspective view of an exemplary arrangement of a grease container;

FIG. 12 shows a top view of an exemplary arrangement of the grease container;

FIG. 13 shows a side view of an exemplary arrangement of the grease container;

FIG. 14 shows the grill of the invention in a transport position;

FIG. 15 shows the detail of the latch arrangement constructed according to the principals of the invention; and

FIG. 16 shows the grill of the invention in a low grilling height position.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

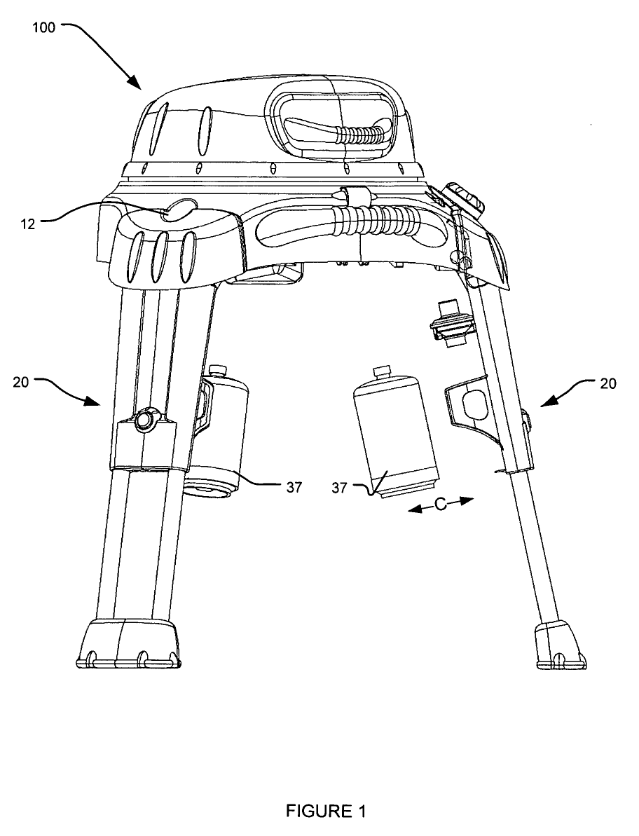

FIG. 1 is a front perspective view of a portable grill 100 constructed according to the principals of the invention. In particular, FIG. 1 shows an embodiment of the portable grill 100 having three legs 20. However, any number of legs 20 may be employed in the grill 100. Attached to the legs 20 may be fuel tanks 37, such as propane tanks, for use with the grill 100. The grill 100 may also include a grill accessory connection port or “Propane take-off” (PTO) port 12 to physically attach and provide fuel to grill accessories as described below.

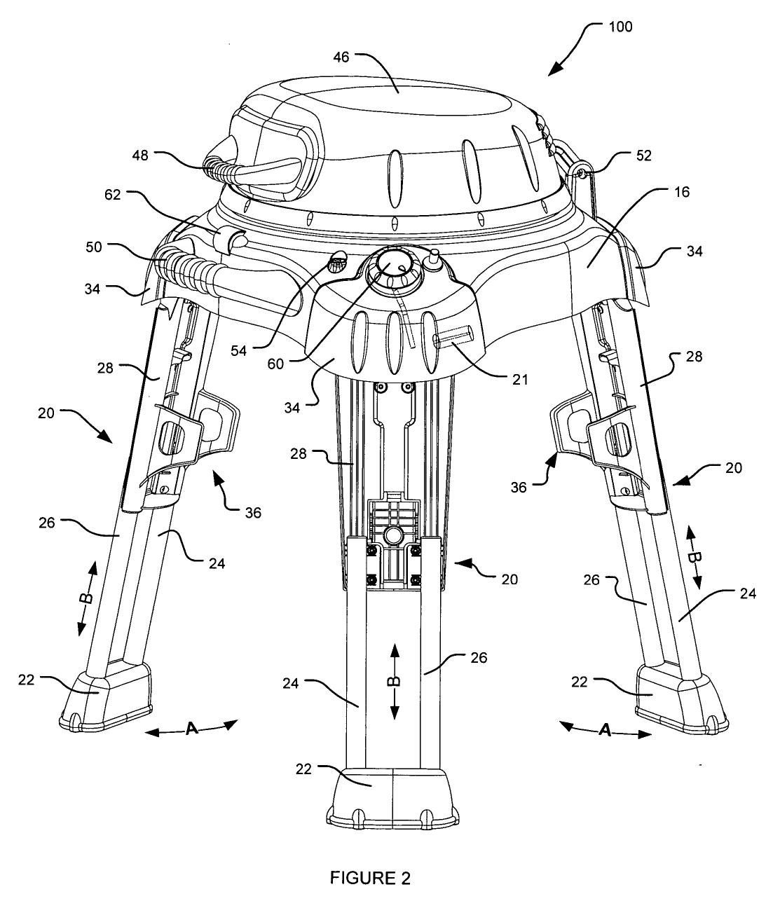

FIG. 2 shows a partial view of the grill of FIG. 1. In particular, leg covers are not shown to reveal leg structure. Positioned at the end of the legs 20 are a plurality of feet 22. The feet 22 provide a larger flat surface that may allow the grill 100 to have a more stable positioning on a ground surface. Moreover, the legs 20 may include two telescoping lower leg portions 24, 26 each. The lower leg portions 24, 26 may be constructed with a single U-shaped tubular construction. The portions 24, 26 extend into and may be attached to the feet 22 with the bottom of the U being arranged inside the feet 22 and thus not shown. The leg portions 24, 26 also may extend into or be attached to an upper leg portion 28. The upper leg portion 28 may include a leg mechanism that receives the leg portions 24, 26 respectively. Together the upper leg portion 28, lower leg portions 24, 26 and the feet 22 provide the grill 100 a stable support structure that will elevate the grill 100 to an easy cooking height. It should be noted that the structure of the legs 20 in FIG. 2 is merely exemplary and any type of legs that are able to form a compact configuration are contemplated by the invention.

To facilitate the positioning of the grill 100 in an upright level position, the grill 100 may include a device that will indicate when the grill is level. In the embodiment shown in FIG. 2, a level indicating device 54 may be attached to the housing 16. The level indicating device 54 may be implemented as a bubble level with a fluid having a bubble inside a clear housing that may show, for example, the bubble in the middle of the housing when the grill 100 is in a level orientation.

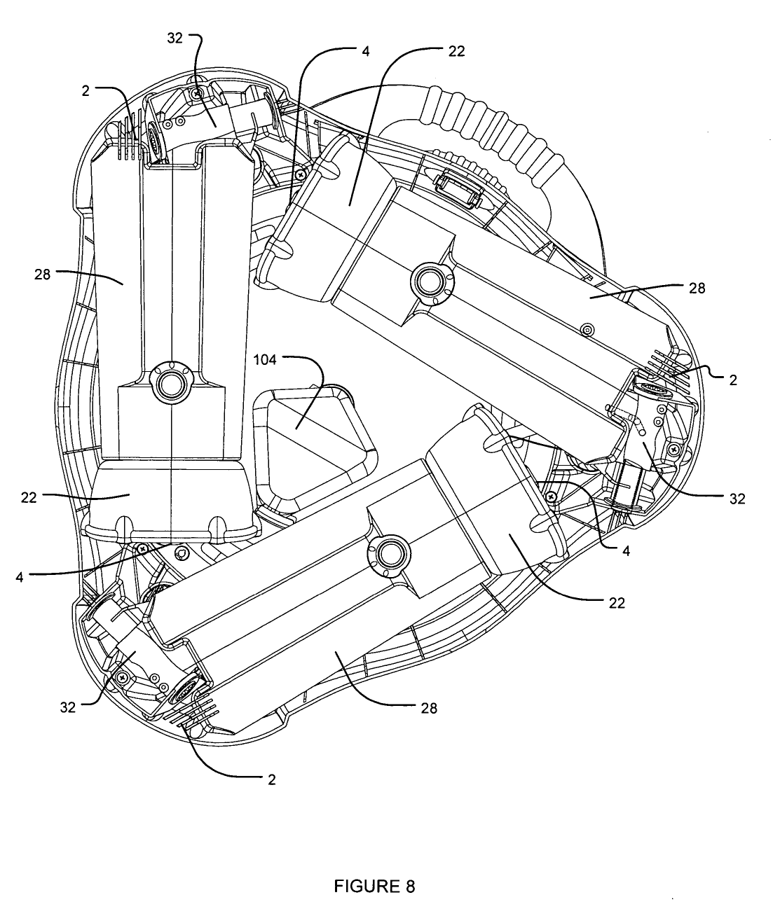

The legs 20 further may have a construction such that the upper leg portion 28 will lock and hold leg portions 24, 26 in place. In particular, the upper leg portion 28 may include a leg mechanism that may grip and hold tight the leg portions 24, 26 to either hold the leg portions 24, 26 in an extended position for positioning the grill in a usable arrangement or the leg mechanism may allow upper leg portions 28 and lower leg portions 24, 26 to move to a retracted position as shown by arrow “B” by merely pulling on legs 20. Additionally, a hinge 32 (shown in FIG. 8) provides pivotal or folding movement of the upper leg portion 28 under the housing 16 and further may include a hinge cover 34 that provides a function of making the grill 100 look more aesthetically pleasing, additionally provides a safety feature of protecting fingers and other bodily parts from interacting with hinge 32, and forms a main structural element of the grill 100. The hinge 32 may allow legs 20 to swing generally in the direction of arrow “A.”

Additionally, the grill 100 may include, in one particular embodiment, a plurality of fuel cylinder holders 36 arranged on upper leg portion 28, inside, and underneath the housing 16. In particular, two of the fuel cylinders 37 that may be held in holders 36 (shown in FIG. 1) are spares and the third may be connected to the grill 100 via an appropriate fuel line. Additionally, one or both of the spares may be connected to an accessory, such as a side burner or a lantern, of the grill 100, for providing gas power to the same at PTO port 12. The holders 36 may be formed of a flexible material, such as plastic, to allow the fuel tank 37 to be inserted as shown by arrow “C.” Accordingly, moving the fuel tank 37 in direction of the arrow “C” will flex the arms of the fuel cylinder holder 36. Once the fuel cylinder 37 is fully inserted, the arms of the fuel cylinder holder 36 then hold the fuel cylinder 37 securely therein.

FIG. 2 further shows the details of housing 16. In particular, the housing 16 includes a grill handle 50. The grill handle 50 may be an aesthetic surface conforming handle which may be used to carry the grill 100 from one place to another or support the grill during the set up or extension of legs 20. The grill 100 further includes a hood 46 positioned and arranged on the top of the grill 100. The hood 46 has an aesthetically pleasing shape that conforms to the remaining part of grill 100. Moreover, as shown in FIG. 2, the hood 46 may have a semi-spherical shape. The hood 46 may further include a hood handle 48 positioned at one side of the hood 46. The hood handle 48 may be used to lift the hood 46 and rotate it out of the way of the cooking area located inside the grill 100. The hood 46 may further include a hood hinge 52 located opposite of the hood handle 48. In this regard, the hood hinge 52 provides a pivot to open hood 46 using hood handle 48.

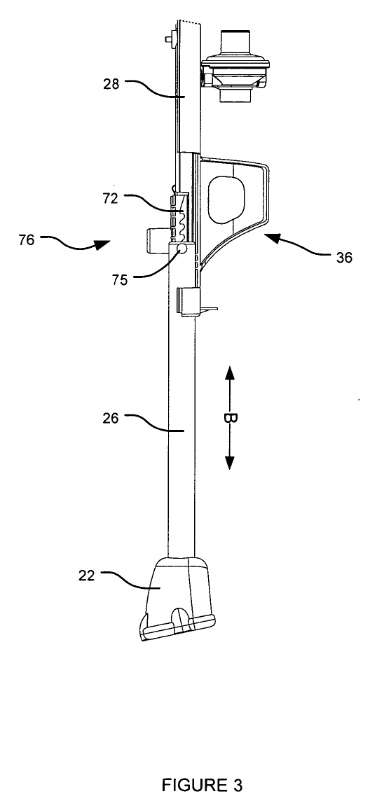

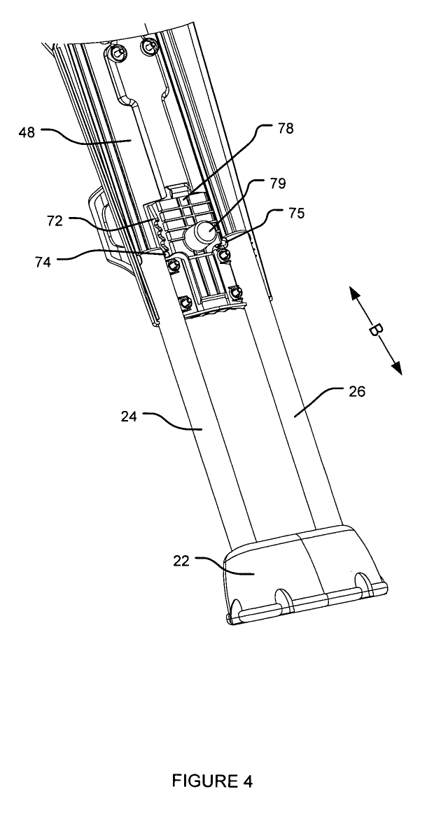

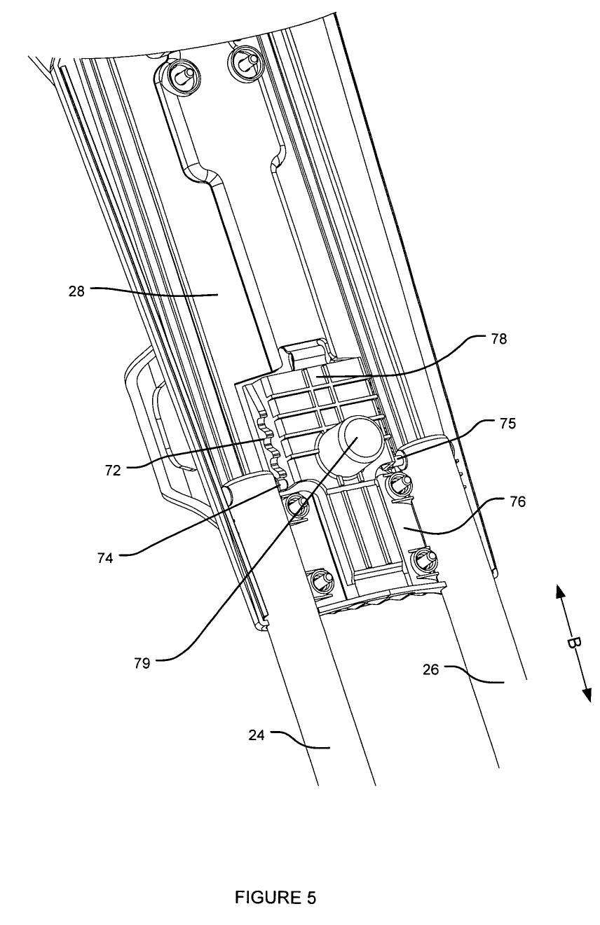

FIGS. 3, 4, and 5, show an exemplary construction of the leg mechanism without leg covers that allows the “B” movement of the legs 20 as illustrated in FIG. 2. Leg covers may be arranged over the FIGS. 3, 4, and 5 leg structure as shown in FIG. 1. In particular, the lower leg portions 24, 26 may be attached to a slide mechanism 76 that allows the lower leg portions 24, 26 to slide with respect to upper leg portion 28 as shown by arrow B. The slide mechanism 76 may be structured to not allow the lower leg portions 24, 26 and the upper leg portions 28 any other degrees of freedom. As further shown in FIGS. 3, 4, and 5, a rack 72 may be attached to the upper leg portion 28 and engaging pins 74, 75 are attached to the lower leg portions 24, 26. The combination of the rack 72 and the engaging pins 74, 75 when engaged with one another prevents the sliding movement between lower leg portions 24, 26 and the upper leg portion 28 in an upward direction but allows downward or extending movement. In other words, rack 72 may be shaped to allow lower leg portions 24, 26 to be easily extended. When the rack 72 and engaging pins 74, 75 are disengaged, the lower leg portions 24, 26, and the upper leg portions 28 are able to slide (Arrow B) to retract the leg portions 24, 26. In this regard, pressing a button 79 moves rack support 78 to disengage the rack 72 from the engaging pins 74, 75. This construction allows the legs to extend the grill to a correct cooking height and retract the legs to form a compact position.

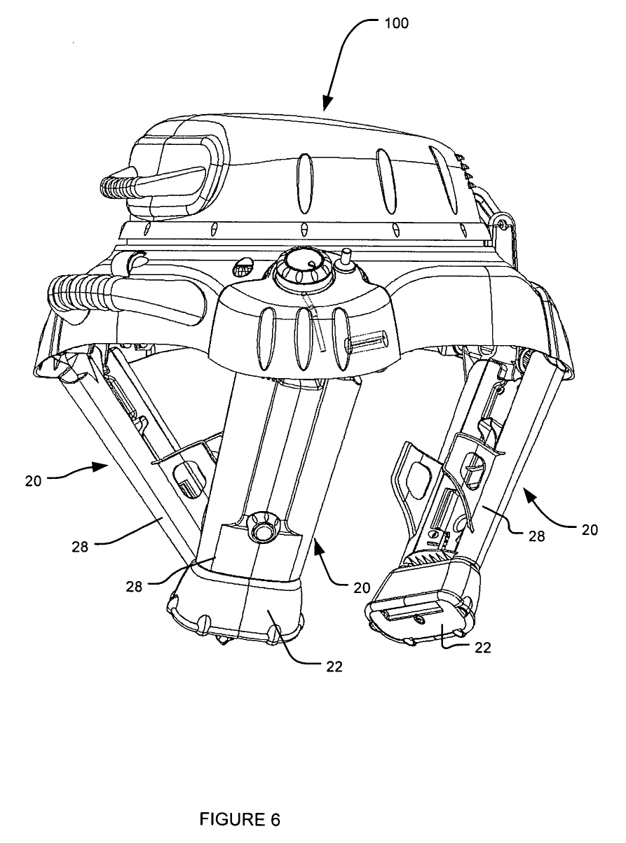

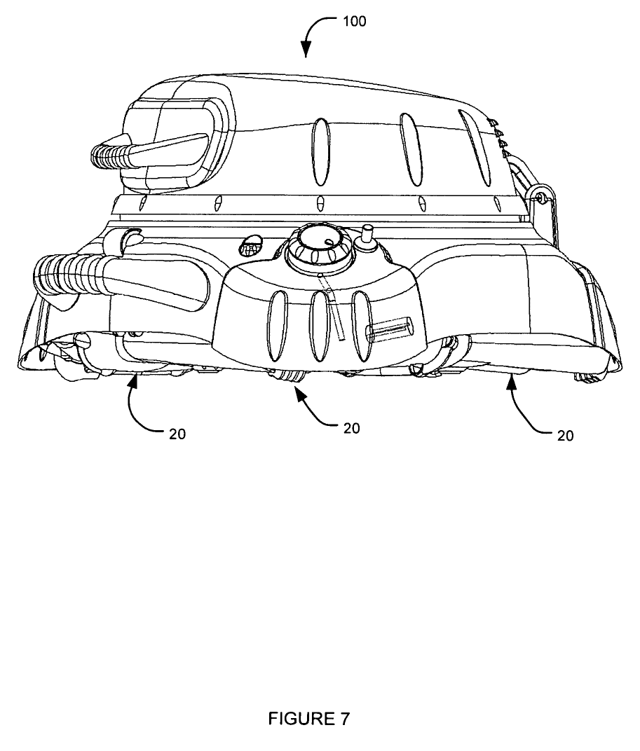

The legs 20 of the grill 100 are further attached to a housing 16. The connection between the legs 20 and the housing 16 is through a pivot or hinge structure 32 (shown in FIG. 8) that allows the legs 20 to fold inward toward the side/center bottom of the grill 100 as shown by arrow “A” in FIG. 2. This side/center folding allows a more compact arrangement. In particular, during rearranging of the grill 100, the leg portions 24, 26 are retracted into the upper leg portion 28 such that only the feet 22 may be seen as shown by FIG. 6 with partially folded legs 2. Then the upper leg portion 28 is rotated about hinge 32 such that the legs are completely folded up and under the housing 16 as shown by FIGS. 7 and 8. In particular, FIG. 8 shows the hinge 32 positioning and leg positioning that may be employed. Additionally, it is contemplated that the grill 100 may be configured to cook when in the compact folded arrangement shown in, for example, FIG. 7. This will allow the grill 100 to be used for picnic table tops and other circumstances were the user does not need or want a higher grilling height.

The grill 100 may also include a leg holding mechanism 4 that holds the legs 20 in the folded position shown in FIGS. 7 and 8. The leg holding mechanism 4 may include a latch structure that may engage an aperture or indent in the legs 20 in the folded position to hold the same. Furthermore the grill 100 may also include a leg securing mechanism 4 that secures the legs 20 in the open position. For example, the leg securing mechanism 4 may include structure, such as a rib structure, that engages with the housing 16 to provide friction to a pivoting action up until the final degrees of rotation of the legs 20 to the open position. In this regard, the legs 20 of the grill 100 are more likely to maintain the open position. Although specific structure is shown in FIG. 8, any holding and securing structure is contemplated by the invention.

The grill 100 may connect to the fuel tank 37 through fuel pipe or conduit for providing cooking fuel to the grill 100. However the grill 100 may optionally employ a safety gas valve that is operative to allow the grill 100 to operate when the grill 100 is in an operating position (legs extended) and may prevent usage of the grill 100 when the grill 100 is in a compact position (legs folded). FIG. 2 shows a possible arrangement of the above-described safety valve. In particular, a safety valve 21 may be arranged on the upper leg 28. The lower end of the safety valve 21 may be connected to a fuel tank 37 (shown in FIG. 1), such as propane tank, that is held in one of the holders 36. The upper end of the safety valve 21 is connected to a conduit (not shown) that may connect to a main valve 60 and a burner of the grill 100. To operate the grill 100, both the safety valve 21 and the main valve 60 must be on. When the upper leg portion 28 is pivoted up and under the grill 100, the safety valve 21 rotates and the conduit does not rotate and causes the safety valve 21 to close and prevent further fuel from discharging from the fuel tank 37 held in holder 36. However, it should be noted that this is merely an alternative to the fuel conduit that is well known in the art.

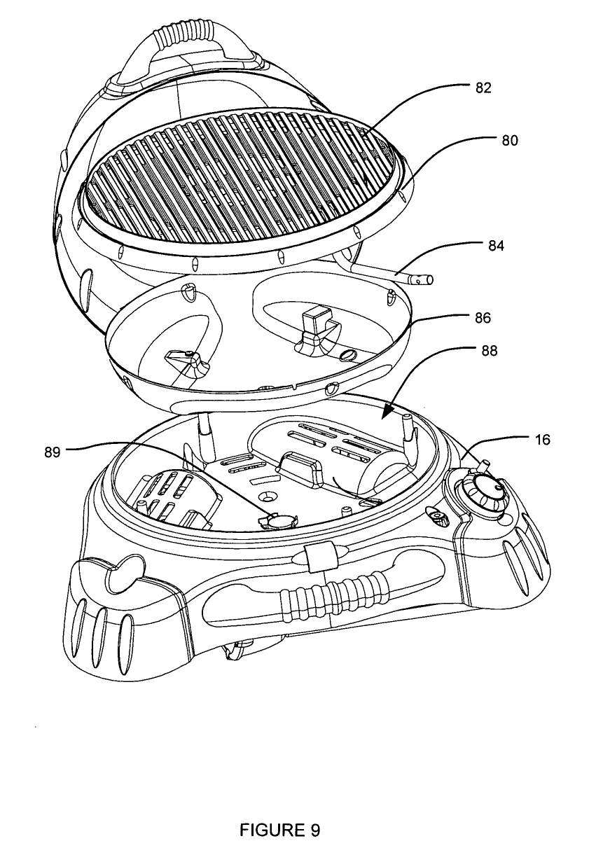

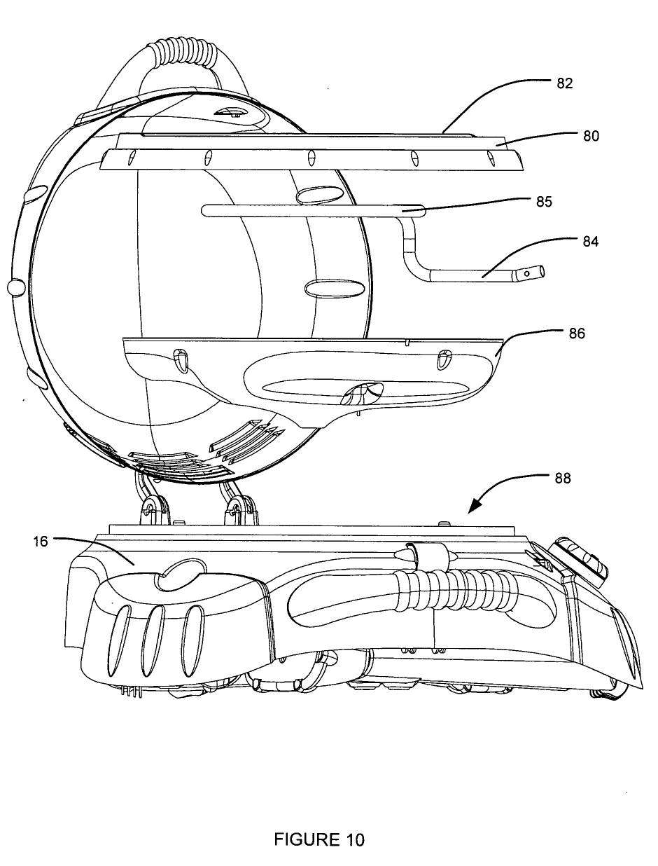

FIGS. 9 and 10 show an exploded view of internal components of the grill of FIG. 1. In particular, FIGS. 9 and 10 show a grill surface 82 that is held by grill support structure 80. The grill surface 82 may be heated for cooking by a burner 85. The burner 85 may be provided fuel with a conduit 84. Below the burner 85 and grilling surface 82 is a fire box 86. Each of these components may be configured to be easily inserted and removed for cleaning and the like. Additionally, the fire box 86 may be arranged to more efficiently utilize the cooking fuel. In this regard, the fire box 86 may include a generally parabolic construction that reflects the heat from the burner 85 toward the cooking grill surface 82.

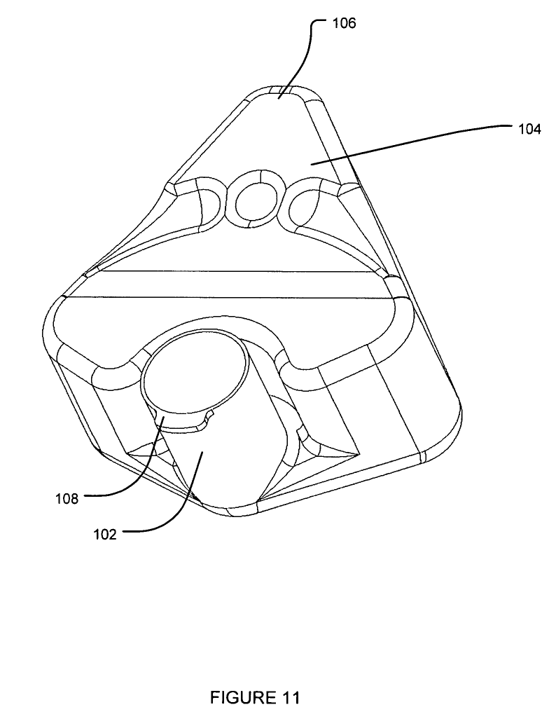

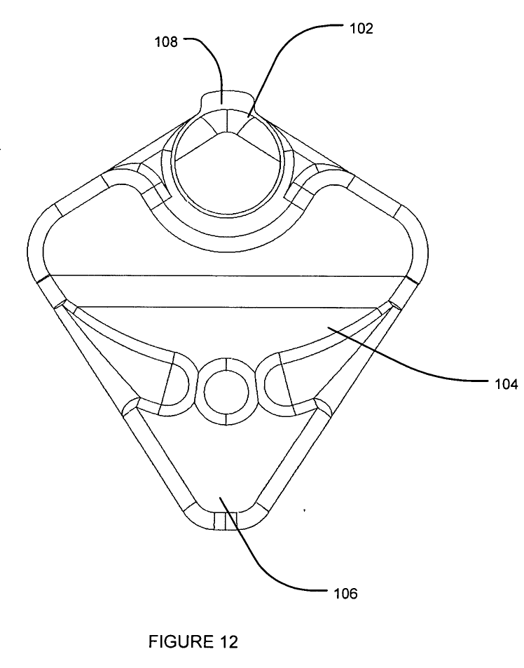

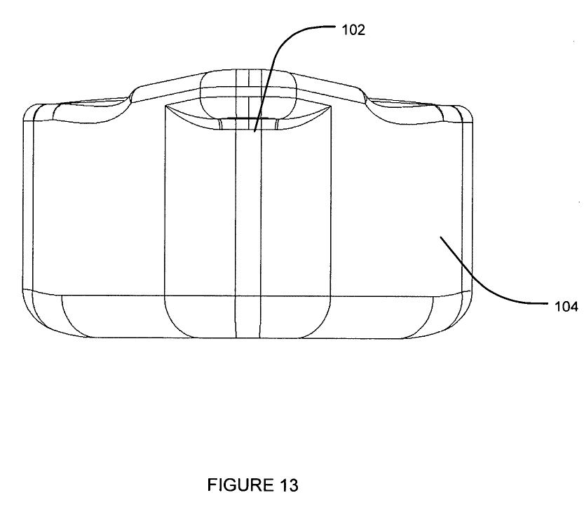

FIGS. 11, 12, and 13 show an exemplary arrangement of a grease container 104. In particular, the grease container 100 may include a connector 102 to attach the grease container 104 to the grill 100 and, more specifically, the grease container attachment 89 shown in FIG. 9. The location of the grease container 104 is also shown in FIG. 8. The arrangement and configuration of the connector 102 allows the grease container 100 to be connected by rotating the body of the grease container 100 to lock the grease container 104 into place at the grease container attachment 89 with a locking tab 108. Additionally, the grease container 104 may employ an arrangement with the cylindrical connector 102 and container 104 that reduces grease spillage from the grease container 104 when the grill is transported. This is because the grease container 104 is orientated and shaped such that grease will flow to a portion 106 that is at the lowest most end of the container 104 and farthest from the connector 102 when the grill 100 is transported.

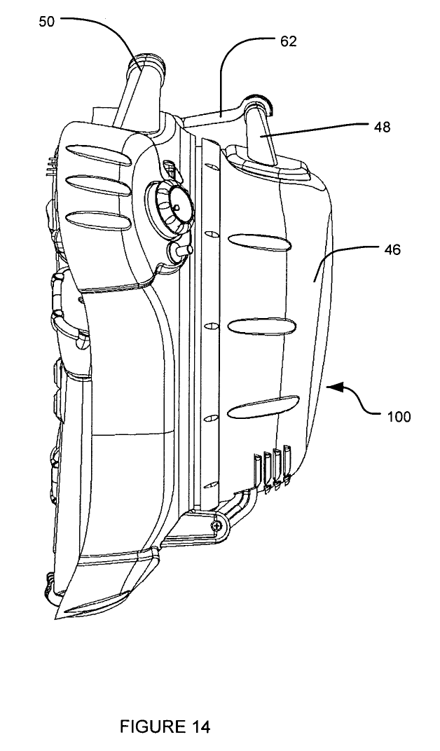

FIG. 14 shows the grill 100 of the invention in a transport position. In particular, the grill 100 includes the grill handle 50 as shown in FIG. 14. The grill 100 may be constructed of lightweight material such that it is easier to carry. Additionally, the grill 100 may be configured such the weight is generally balanced (center of gravity below grill handle 50) and thus the grill 100 may hang straight down. In this regard, a user carrying the grill 100 holding handle 50 has less of a tendency for the grill 100 to lean against the user.

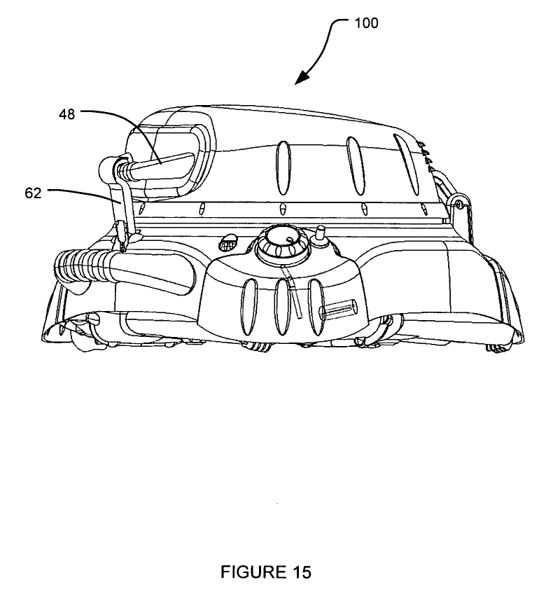

An additional safety feature of the grill 100 is a hood latch device 62. Because the grill 100 may be transported in an orientation that is not upright, there may be a tendency for the hood 46 to open. In this regard, the grill 100 may include a hood latch device 62 that maintains the hood 46 in a closed position. In the particular embodiment shown in FIG. 2, a hood latch 46 is arranged in an aperture of the housing 16 in the disconnected position. To lock the hood 46 in place, a user may grab the hood latch 46, extend it from the housing 16 and flex an end of the hood latch 46 to hook to the hood 46. The latched configuration is shown in FIG. 15.

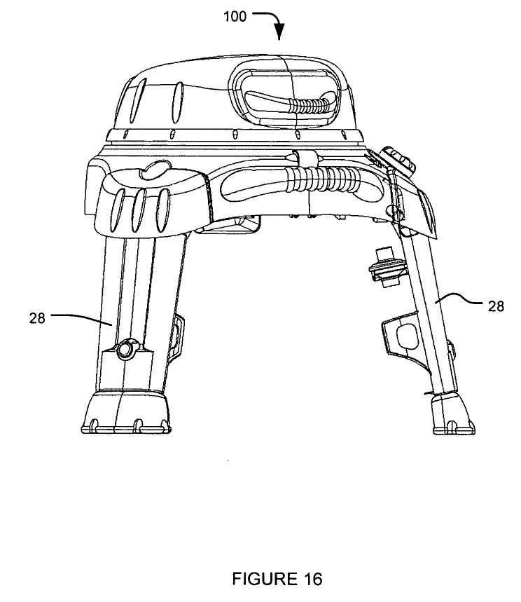

FIG. 16 shows the grill of the invention in an intermediate or low grilling height position. In particular, the lower leg portions 24, 26 have been retracted up and into the upper leg portion 28, thus reducing the height of the grill 100. This configuration of a lower grilling height may be ideal for grilling from a seated position or in other situations.

Although the grill 100 is shown as a gas grill, it can also be used as a charcoal grill, electric grill, and the like. In such an arrangement, it may not have the plurality of gas cylinders 34. Additionally, it is contemplated that the grill 100 may have additional accessories usable therewith. In particular, the grill may be used together with a side burner housing, a battery powered flashlight support, gas lantern, a side table or the like for use with the invention with PTO port 12. In this regard, the grill 100 may be configured to carry one or more of these accessories such as inside the grill 100.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A portable grill comprising:
a grill housing that holds a grill structure;
at least one pivot connection;
a plurality of upper leg portions that are pivotally connected to said grill housing by said at least one pivot connection; and
a plurality of lower leg portions attached to said upper leg portions,
wherein said plurality of lower leg portions are configured to move with respect to said plurality of upper leg portions to form a compact position of the grill.

2. The portable grill according to claim 1 wherein said plurality of upper leg portions comprises three upper leg portions and said at least one pivot connection comprises three pivot connections, each of said upper leg portions is associated with one of said pivot connections, said pivot connections are configured to pivot said upper leg portion from a first position, supporting said grill housing, to a second compact position.

3. The portable grill according to claim 1 wherein said plurality of lower leg portions further comprises a rack and at least one engaging pin,
wherein said rack and said at least one engaging pin limit movement between at least one of said plurality of lower leg portions and at least one of said plurality of upper leg portions.

4. The portable grill according to claim 1 further comprising:
a gas cylinder support arranged on said upper leg portion;
a grill handle connected to the grill; and
a grill hood hingedly connected to the grill.

5. The portable grill according to claim 1 further comprising:
a grilling surface;
a gas burner arranged below said grilling surface;
a parabolic fire box arranged below said gas burner; and
a grease container arranged below said fire box.

6. The portable grill according to claim 5 further comprising:
a safety valve that selectively connects a gas cylinder to said burner.

7. The portable grill according to claim 1 further comprising:
an accessory connection configured to at least one of support a grill accessory or provide fuel to the grill accessory.

8. The portable grill according to claim 1 wherein said grill is one of a gas grill, electric grill, or a charcoal grill.

9. The portable grill according to claim 1 wherein said grill comprises a lower leg portion locking mechanism,
wherein said locking mechanism maintains said lower leg portions in a locked position relative to said upper leg portion.

10. The portable grill according to claim 1 wherein the grill is operable in the compact position where said plurality of lower legs are fully retracted and said plurality upper legs are folded, a position where said plurality of lower legs are fully extended and said plurality upper legs are unfolded, and an intermediate position where said plurality of lower legs are retracted and said plurality of upper legs are unfolded.

11. The portable grill according to claim 1 further comprising:
a level indicator that indicates when the grill is in a level orientation.

12. A portable grill comprising:
a grill housing that holds a grill structure;
at least one pivot connection;
a plurality of upper leg portions that are pivotally connected to said grill housing by said at least one pivot connection; and
a plurality of lower leg portions attached to said upper leg portions,
wherein said plurality of lower leg portions are configured to retract into said plurality of upper leg portions to form a compact position of the grill.

13. The portable grill according to claim 12 wherein said plurality of upper leg portions comprises three upper leg portions and said at least one pivot connection comprises three pivot connections, each of said upper leg portions is associated with one of said pivot connections, said pivot connections are configured to pivot said upper leg portion from a first position, supporting said grill housing, to a second compact position.

14. The portable grill according to claim 12 wherein said plurality of lower leg portions further comprises a rack and at least one engaging pin,
wherein said rack and said at least one engaging pin limit movement between at least one of said plurality of lower leg portions and at least one of said plurality of upper leg portions.

15. The portable grill according to claim 12 further comprising:
a gas cylinder support arranged on said upper leg portion;
a grill handle connected to the grill; and
a grill hood hingedly connected to the grill.

16. The portable grill according to claim 12 further comprising:
a grilling surface;
a gas burner arranged below said grilling surface;
a parabolic fire box arranged below said gas burner; and
a grease container arranged below said fire box.

17. The portable grill according to claim 16 further comprising:
a safety valve that selectively connects a gas cylinder to said burner.

18. The portable grill according to claim 12 further comprising:
an accessory connection configured to at least one of support a grill accessory or provide fuel to the grill accessory.

19. The portable grill according to claim 12 wherein said grill is one of a gas grill, electric grill, or a charcoal grill.

20. The portable grill according to claim 12 wherein said grill comprises a lower leg portion locking mechanism,
wherein said locking mechanism maintains said lower leg portions in a locked position relative to said upper leg portion.
